(19) United States
(12) Patent Application Publication
(10) Pub. No.: US 2021/0121037 A1
(43) Pub. Date: Apr. 29, 2021

(54) DRYING AND/OR CLEANING CLOTH

(71) Applicant: Jens FRITSCH, Bornheim (DE)

(72) Inventor: Jens FRITSCH, Bornheim (DE)

(21) Appl. No.: 17/075,158

(22) Filed: Oct. 20, 2020

(30) Foreign Application Priority Data
Oct. 23, 2019 (DE) 202019105895.1

(51) Int. Cl. A47L 13/16; A47K 10/02; D04H 1/4334; D04H 1/435; D03D 27/08

(52) U.S. Cl. CPC A47L 13/16; A47K 10/02; D04H 1/4334; D10B 2331/04; D03D 27/08; D10B 2331/02; D04H 1/435

(57) ABSTRACT

Drying and/or cleaning cloth with a square surface with two sides which are each delimited by two longitudinal edges and two transverse edges, wherein the drying and/or cleaning cloth in the area has an opening for reaching through at least one transverse edge or one longitudinal edge.

The invention relates to a drying and/or cleaning cloth having a rectangular surface having two sides that are respectively delimited by two longitudinal edges and two transverse edges.

Such drying and/or cleaning cloths, which are used inter alia for drying vehicles after vehicle washing, or for picking up polishing residues, are known from practical use.

Such drying and/or cleaning cloths are also used for household cleaning or for drying off pets.

It is disadvantageous in this context that in the context of the activities described above, it can happen that the drying and/or cleaning cloth is accidentally dropped and thus comes into contact with the ground. Dirt can thereby get onto the cloth and can then, upon further use, for example not only get the vehicle dirty (again) but also cause scratches or other damage on the vehicle due to hard constituents such as sand grains, pebbles, etc. The same applies analogously in terms of household use, and similarly also when drying off pets, which can also suffer consequences.

The object of the invention is to avoid the aforementioned disadvantages and to describe a drying and/or cleaning cloth with which the risk of negative effects due to accidental dropping of the drying and/or cleaning cloth is reliably avoided.

This object is achieved, in the context of a drying and/or cleaning cloth of the species, in that the drying and/or cleaning cloth comprises, in the vicinity of at least one transverse edge or one longitudinal edge, an opening to be reached through. The drying and/or cleaning cloth is thereby retained by the user's arm that is passed through the opening, and thus cannot drop even if the user is inadvertently no longer gripping the cloth with his or her hand.

At least one opening can preferably be embodied as a slit that is oriented parallel to the respective transverse edge or longitudinal edge in the vicinity of which it is provided, so that on the one hand it is possible to reach through it, and on the other hand as little material as possible of the drying and/or cleaning cloth is lost because of the opening.

The slit can be provided at a distance of approximately 5 cm to 15 cm, preferably 8 cm to 12 cm, very preferably approximately 10 cm, from the corresponding respective transverse edge or longitudinal edge, so that on the one hand the opening is provided as close as possible to the corresponding edge for good handling of the drying and/or cleaning cloth, and on the other hand a sufficient distance from the respective edge is provided for sufficient stability of the drying and/or cleaning cloth in the region between the opening and the corresponding edge.

The slit can also have a length of approximately 5 cm to 15 cm, preferably 8 to 12 cm, very preferably approximately 10 cm, both so that hands of ordinary dimensions can reach through it, and so that as little material as possible of the drying and/or cleaning cloth is lost because of the opening.

The slit can furthermore be arranged approximately centeredly with respect to the length of the corresponding respective transverse edge or longitudinal edge, so that good handling of the drying and/or cleaning cloth is made possible, since sufficient material of the drying and/or cleaning cloth remains on either side of the user's hand that has passed through the opening.

According to the present invention, at least one side of the drying and/or cleaning cloth can have a napped surface; preferably, both sides of the drying and/or cleaning cloth each have a napped surface. Good sliding along the surface being processed results therefrom.

In a preferred exemplifying embodiment of the invention, at least one napped surface can be constituted by a terrycloth, preferably a towel terrycloth, thus yielding a surface that is both pleasant and highly absorbent.

According to the present invention, the edge region can be hemmed with a border made of a textile material, so that fraying of the drying and/or cleaning cloth in the edge regions is avoided, and the border in turn is similar in softness to the drying and/or cleaning cloth and thus does not produce negative effects on or damage to the surface being processed. Alternatively or additionally, a seam positioned at a short distance from the edge can also be provided. The edge can also be protected from fraying by heat-sealing. The edge can have been generated by laser cutting, in which case creation of the edge and heat-sealing have occurred simultaneously in one working step. Heat-sealing of the edge can have occurred independently of, and if applicable in addition to, heat-sealing of the cloth plies.

The opening can also be hemmed with a border made of a textile material, so that fraying of the drying and/or cleaning cloth in the vicinity of the opening(s) is avoided, and the border in turn is similar in softness to the drying and/or cleaning cloth and thus does not cause negative effects on or damage to the surface being processed. Alternatively or additionally, a seam can also be provided at a short distance from the edge.

In a preferred exemplifying embodiment of the invention, the drying and/or cleaning cloth can have a double-ply structure having two cloth plies, the two cloth plies being provided adjacently to one another on the back sides with a possibly present napped side facing outward. A simple material having only one napped side can thus be used for the drying and/or cleaning cloth, and two napped sides can nevertheless be implemented on the drying and/or cleaning cloth. The two sides can be made of identical cloth plies, although different cloth plies having material properties that differ from one another can also be used for the two sides of the drying and/or cleaning cloth.

The two cloth plies can be heat-sealed to one another on their rear surfaces at several points arranged apart from one another, preferably heat-sealed to one another over the entire surface, so that the drying and/or cleaning cloth remains permanently flat and cloth-shaped and cannot puff up, and no shifting of the two cloth plies with respect to one another can occur.

Advantageously, at least one side of the drying and/or cleaning cloth can be embodied as a microfiber cloth; preferably, both sides of the drying and/or cleaning cloth can be respectively embodied as a microfiber cloth, thereby yielding particularly good absorbance in terms of dirt, dust, and moisture.

According to the present invention, at least one side of the drying and/or cleaning cloth can be made of a mixed fabric having polyester and polyamide constituents; preferably, both sides of the drying and/or cleaning cloth can be respectively made of a mixed fabric having polyester and polyamide constituents.

The mixed fabric can have a composition having approximately 80% polyester and approximately 20% polyamide.

The drying and/or cleaning cloth can also have a weight per unit area of approximately 800 g/m².

In a preferred exemplifying embodiment of the invention, the drying and/or cleaning cloth can be square or rectangular, having a ratio of longitudinal edge to transverse edge of approximately 1.5 to 1.7, preferably 1.6.

Exemplifying embodiments of the invention will be explained below and are depicted in the drawings, in which:

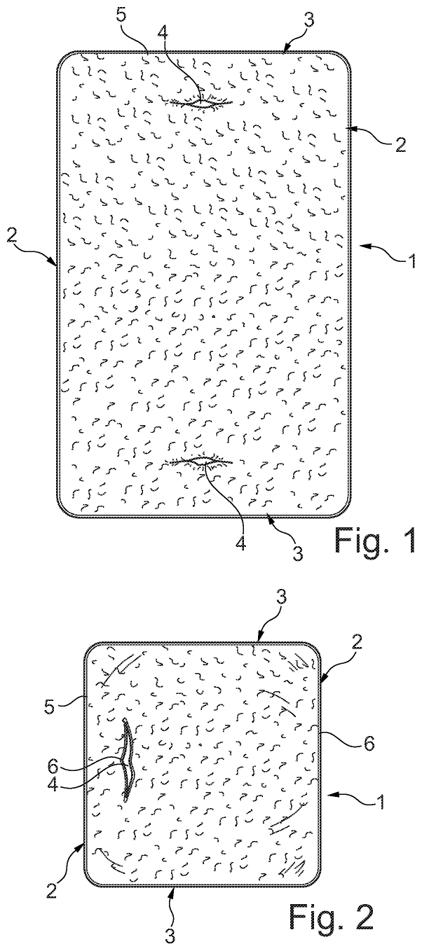

FIG. 1 shows a first exemplifying embodiment of a drying and/or cleaning cloth according to the present invention; and

FIG. 2 shows a second exemplifying embodiment of a drying and/or cleaning cloth according to the present invention.

In all the Figures, matching reference characters are used for identical or similar parts.

The Figures each show a drying and/or cleaning cloth 1 having a rectangular surface having two sides (front side and rear side). The two sides are respectively delimited by two longitudinal edges 2 and two transverse edges 3.

Drying and/or cleaning cloth 1 shown in FIG. 1 is embodied rectangularly, longitudinal edges 2 each being 1.6 times as long as transverse edges 3. Longitudinal edges 2 can each be, for example, 80 cm long, while transverse edges 3 are then each 50 cm long.

The rectangular drying and/or cleaning cloth 1 comprises, in the vicinity of both transverse edges 3, a respective opening 4 to be reached through, so that when drying and/or cleaning cloth 1 is being used, it is held by the user's arm (not shown in the drawings) passed through opening 4, and kept from being dropped.

Openings 4 are each embodied as a slit of approximately 10 cm which is oriented parallel to transverse edge 3 in whose vicinity it is provided, and is arranged approximately centeredly with respect to the length of transverse edge 3. The slit-shaped opening 4 is provided respectively at a distance of approximately 10 cm from the corresponding respective transverse edge or longitudinal edge.

Both sides of drying and/or cleaning cloth 1 have a respective napped surface similar to a terrycloth.

The edge region of drying and/or cleaning cloth 1 is hemmed with a border 5 made of a textile material with a seam 6, while opening 4 is protected from fraying by heat-sealing. The opening can have been generated by laser cutting, in which case creation of the opening and welding have occurred simultaneously in one working step. Heat-sealing of the edge is effected independently of, and if applicable in addition to, heat-sealing of the cloth plies.

Drying and/or cleaning cloth 1 shown in FIG. 2 is identical in most respects to the subject matter shown in FIG. 1. Divergently from the subject matter in FIG. 1, however, drying and/or cleaning cloth 1 shown in FIG. 2 is embodied to be square. Edges 2, 3 can each be, for example, 40 cm or 50 cm long.

Drying and/or cleaning cloth 1 that is shown also has only a single opening 4 to be reached through. Said opening is again 10 cm long and is provided at a distance of 10 cm from the adjacent edge. Opening 4 is protected from fraying here by a seam 6 positioned at a short distance from the edge of opening 4.

1. A drying and/or cleaning cloth (1) having a rectangular surface having two sides that are respectively delimited by two longitudinal edges (2) and two transverse edges (3),
wherein the drying and/or cleaning cloth (1) comprises, in the vicinity of at least one transverse edge (3) or one longitudinal edge (2), an opening (4) to be reached through.

2. The drying and/or cleaning cloth (1) according to claim 1, wherein at least one opening (4) is embodied as a slit that is oriented parallel to the respective transverse edge (3) or longitudinal edge (2) in the vicinity of which it is provided.

3. The drying and/or cleaning cloth (1) according to claim 2, wherein the slit is provided at a distance of approximately 5 cm to 15 cm, preferably 8 cm to 12 cm, very preferably approximately 10 cm, from the corresponding respective transverse (3) edge or longitudinal edge (2).

4. The drying and/or cleaning cloth (1) according to claim 2, wherein the slit has a length of approximately 5 cm to 15 cm, preferably 8 to 12 cm, very preferably approximately 10 cm.

5. The drying and/or cleaning cloth (1) according to claim 2, wherein the slit is arranged approximately centeredly with respect to the length of the corresponding respective transverse edge (3) or longitudinal edge (2).

6. The drying and/or cleaning cloth (1) according to claim 1, wherein at least one side of the drying and/or cleaning cloth (1) has a napped surface; preferably, both sides of the drying and/or cleaning cloth (1) each have a napped surface.

7. The drying and/or cleaning cloth (1) according to claim 6, wherein at least one napped surface is constituted by a terrycloth, preferably a towel terrycloth.

8. The drying and/or cleaning cloth (1) according to claim 1, wherein the edge region of the longitudinal edges (2) and of the transverse edges (3) is hemmed with a border (5) made of a textile material; and/or a seam (6) positioned at a short distance from the respective edge is provided.

9. The drying and/or cleaning cloth (1) according to claim 1, wherein the opening (4) is hemmed with a border (5) made of a textile material; and/or a seam (6) positioned at a short distance from the respective edge is provided.

10. The drying and/or cleaning cloth (1) according to claim 1, wherein the drying and/or cleaning cloth (1) has a double-ply structure having two cloth plies, the two cloth plies being provided adjacently to one another on the back sides with a possibly present napped side facing outward.

11. The drying and/or cleaning cloth (1) according to claim 10, wherein the two cloth plies are heat-sealed to one another on their rear surfaces at several points arranged apart from one another, preferably are heat-sealed to one another over the entire surface.

12. The drying and/or cleaning cloth (1) according to claim 1, wherein at least one side of the drying and/or cleaning cloth (1) is embodied as a microfiber cloth; preferably, both sides of the drying and/or cleaning cloth (1) are respectively embodied as a microfiber cloth.

13. The drying and/or cleaning cloth (1) according to claim 1, wherein at least one side of the drying and/or cleaning cloth (1) is made of a mixed fabric having polyester and polyamide constituents; preferably, both sides of the drying and/or cleaning cloth (1) are respectively made of a mixed fabric having polyester and polyamide constituents.

14. The drying and/or cleaning cloth (1) according to claim 13, wherein the mixed fabric has a composition having approximately 80% polyester and approximately 20% polyamide.

15. The drying and/or cleaning cloth (1) according to claim 1, wherein the drying and/or cleaning cloth (1) has a weight per unit area of approximately 800 g/m².

16. The drying and/or cleaning cloth (1) according to claim 1, wherein the drying and/or cleaning cloth (1) is square or rectangular, having a ratio of longitudinal edge (2) to transverse edge (3) of approximately 1.5 to 1.7, preferably 1.6.

17. The drying and/or cleaning cloth (1) according to claim 3, wherein the slit has a length of approximately 5 cm to 15 cm, preferably 8 to 12 cm, very preferably approximately 10 cm.

18. The drying and/or cleaning cloth (1) according to claim 3, wherein the slit is arranged approximately centeredly with respect to the length of the corresponding respective transverse edge (3) or longitudinal edge (2).

19. The drying and/or cleaning cloth (1) according to claim 4, wherein the slit is arranged approximately centeredly with respect to the length of the corresponding respective transverse edge (3) or longitudinal edge (2).
